(19) United States
(12) Patent Application Publication
(10) Pub. No.: US 2019/0367199 A1
(43) Pub. Date: Dec. 5, 2019

(54) METHOD AND DEVICE FOR FORMING A BATCH OF PRODUCTS OF DIFFERENT TYPES

(71) Applicant: GEBO PACKAGING SOLUTIONS FRANCE, Reichstett (FR)

(72) Inventors: Anthony GEHIN, Reichstett (FR); Franck KLOTZ, Laval (CA); Patrick HUTTER, Reichstett (FR)

(21) Appl. No.: 16/474,045

(22) PCT Filed: Dec. 22, 2017
(86) PCT No.: PCT/FR2017/053842

§ 371 Date: Jun. 26, 2019

(30) Foreign Application Priority Data
Dec. 27, 2016 (FR) 1663415

(51) Int. Cl. B65B 35/36; B65B 35/40; B65B 35/44; B65B 35/54; B65G 47/68

(52) U.S. Cl. CPC B65B 35/36; B65B 35/405; B65B 2220/14; B65B 35/54; B65G 47/681; B65B 35/44

(57) ABSTRACT

The present invention relates to a method for forming a batch of products on a conveying line, upstream of a packaging station of said batch, said batch containing products of at least two different types, specifically type A and type B, said conveying line including a conveyor arranged in the longitudinal direction, and designed to move the products in parallel rows towards the packaging station, and at least one accumulation surface arranged adjacent to and flush with said conveyor. This method includes formation of at least one row of A products on the conveyor and transverse cyclical transfer by lots of B products from said accumulation surface to the conveyor. The present invention also relates to a specially designed device for implement a method according to the invention.

The present invention relates to the domain of product conveyance on an industrial processing line. More specifically, the invention relates to a method and a product feed device that is able to form batches that contain products of different types.

There are solutions for making batches that contain products of different types. The device is placed in front of a parceling machine in order to make parcels of products of different types, or a boxing machine for example. However, the existing solutions require a complex installation. A dedicated production line is often necessary, which increases costs and production times, and requires a large production volume of identical parcels to offset the related investments.

Document DE202005019906proposes a device in which packets made up of different bottles are created from individual conveyors each conveying a different type of bottle. This installation is very inflexible, cannot be retrofitted to an existing installation and requires a dedicated device for each type of batch to be created.

Document DE102008037833 proposes a device designed to distribute products taken from uniform batches among non-uniform batches. Again, the installation is complex and cannot be retrofitted to an existing installation.

The present invention is intended to at least partially overcome these drawbacks by taking products of a type different from the other products from the side of the flow subsequently sequenced into successive groups and in an end row that defines the edge of said flow.

For this purpose, the invention proposes a method for forming a batch of products on a conveying line, upstream of a packaging station of said batch, said batch containing products of at least two different types, specifically type A and type B, said conveying line including a conveyor arranged in the longitudinal direction, and designed to move the products in parallel rows towards the packaging station, and at least one accumulation surface arranged adjacent to and flush with said conveyor, this method being characterized in that it includes the following steps:
formation of at least one row of A products on the conveyor,
transverse cyclical transfer by lots of B products from said accumulation surface to the conveyor, to obtain a column comprising type A products and type B products successively.

The flow, which is subsequently separated into groups that are separated longitudinally from one another, is made up, of several longitudinal rows arranged beside one another, with two of these rows forming the two end rows or edge rows. The aforementioned cyclical transfer thus moves the products, by transverse pushing, from an accumulation surface on the same side as the conveyor to one of the edge rows, This transfer thus enables the flow to be added to and completed by adding a row to the side thereof.

These arrangements enable a continuous flow of products of different types (A and B) to be formed on the conveyor in a simple and flexible manner, requiring little adaptation for use on a line containing just one product type, and a machine arranged downstream can for example package the batches containing products of different types. Indeed, it may be sufficient to provide an opening on the side of an existing conveyor to enable different products to be moved against the flow already created upstream.

According to other features:
B products may be transferred to a row dedicated to B products, thereby enabling the formation of two distinct rows, one comprising A products and the other B products. Thus, the edge row, which receives products of a type different to the product type already present in the flow, is uniform,
the row of A products can be interrupted, and the B products can be transferred to the row of A products at the interruption point thereof, enabling formation of a row that comprises type A products and type B products successively. In other words, circulation of products in the edge row is stopped to receive products of another type in said row, before circulation is restarted. This results in a non-uniform edge row. It can be seen here that the edge row receiving products from the side already contains products and is not formed exclusively by the lateral transfer,
the A products can be loaded onto the conveyor upstream of the transfer of B products, or alternatively the A products can be moved onto the conveyor from a zone facing the zone that the B products are moved to. In this case, each of the edge rows receives products by transverse transfer.

Thus, the method can be implemented using a device requiring limited adaptation for use on a line usually used to handle A products only,
the speed of said conveyor can be slowed down, preferably to a stop, during the, transfer of B products, then increased to a nominal value greater than the speed of forward movement of the rows in a downstream machine, thereby limiting the risk of products falling during transfer of B products onto the conveyor,
the method for forming a batch of products of different types (A and B) can also include the, following steps:
   formation of at least two rows, east one of which includes A products on the conveyor,
   stopping the row with the A products using stopping means to cause an interruption of the row,
   transfer of at least one B product to said interruption, such as to create a row with two products (A and B).

This transfer is transverse and is carried out by moving the products into the row forming an edge of the flow. Batches made up of products of different types, either within a single row or between rows, can then be obtained.
the method for forming a batch of products of different types (A and B) can also include the following steps:
   formation of at least two rows, at least one of which includes A products on the conveyor,
   transfer of B products from an accumulation surface arranged on one side of said conveyor,
   transfer of C products from an accumulation surface arranged on the other side of said conveyor, in which the C products can be identical to the 6 products.

Thus, batches made up of three different types of products can be formed simply and reliably using a flexible installation that can be retrofitted to a line usually used to handle just one product type.
B products from a second accumulation surface can be transferred to the conveyor once the products from the first accumulation surface have all been transferred, thereby enabling the feed of B products to the conveyor to be continuous, even if one of the accumulation surfaces is empty.

The present invention also relates to a device for implementing a method according to the invention, including a conveyor provided with at least two corridors, i.e. having at least two separate corridors for the circulation of a broad row of a single product in each corridor. This device is characterized in that it includes at least one accumulation surface arranged immediately beside and flush with said conveyor, and means for transferring products from said accumulation surface to the conveyor, on the corridor closest to the accumulation surface, said transfer means being preferably pushing means.

Such arrangements enable the device according to the invention to form batches of products of different types in different rows.

According to other features:
the device for implementing a method according to the invention can include at least one second accumulation surface arranged on the same side of said conveyor as the first accumulation surface, and the transfer of products to the conveyor can be continuous, even if one of the accumulation surfaces is empty. The device can also have a succession of accumulation surfaces arranged along the conveyor, each being upstream of the last, and the products moved upstream by the surface are transferred to the row that is furthest away from the row to which the products moved by a downstream accumulation surface are transferred. In other words, each surface alongside the edge of the conveyor feeds a circulation corridor, gradually as the flow moves forward. Again, each accumulation surface moves the products into an end row of the flow at that point, and the flow can be further added to downstream from the same side from another surface, and so on,
said conveyor can have a variable-speed motor ranging from a near-zero speed, in order to transfer products from the accumulation surface, to a maximum speed, in order to convey said products downstream, thereby reducing the risk of products falling when being transferred,
said conveyor can include means for stopping a row that are designed to temporarily stop the products upstream of said stopping means of said row to enable the transfer means to transfer at least one product from the accumulation surface to said row, thereby enabling the production of batches of products of different types in the same row, for example a row of type A products into which are periodically inserted one or more type B products,
said accumulation surface can be arranged on an independently movable shuttle, enabling the products to be transferred at a relative speed between the accumulation surface and the conveyor that is reduced or zero,
the device for implementing a method according to the invention may include unpacking means designed to feed said accumulation surface from a box, preferably a robot designed to simultaneously pick the batch or a sub-batch of B products from a box, providing simple and flexible means for feeding the accumulation surface,
the device implementing a method according to the invention may also include an input conveyor arranged substantially parallel to the conveyor on the other side of the accumulation surface in relation to said conveyor, and transfer means from said input conveyor to the accumulation surface, which enables the accumulation surface to be fed entirely automatically.

The advantage provided by the present invention is the option of forming non-uniform batches of products of different types using a simple, inexpensive and efficient installation operating continuously. Furthermore, this solution is very easy to retrofit to existing installations, since an accumulation surface need simply be arranged beside the main conveyor in order to transfer products from the side to the closest circulation corridor or row.

The present invention can be better understood from the detailed description provided below with reference to the attached figures, in which:

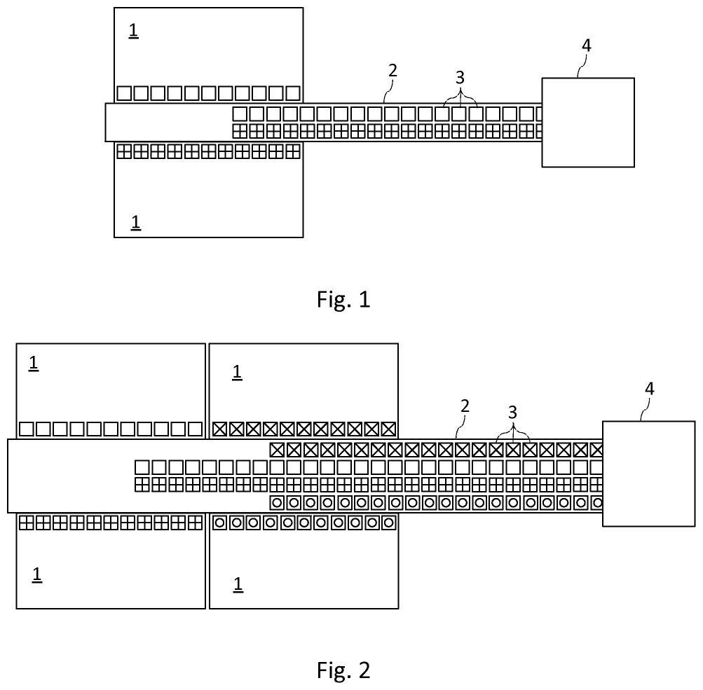

FIG. 1 is a schematic top view of a device according to a first embodiment of the invention,

FIG. 2 is a schematic top view of a device according second embodiment of the invention.

The device according to FIG. 1 has at least one accumulation surface 1 feeding a conveyor 2 with a given type of product 3. Upstream of each accumulation surface 1 there is a conveyor (not shown) feeding the accumulation surface 1 with the flow of products 3 along the edge opposite the edge of the surface that is arranged against the conveyor 2. Once in place on the accumulation surfaces 1, the products 3 can remain there for a certain amount of time, or be immediately transferred to the conveyor 2 using transfer means (not shown). The products 3 are transferred from the respective accumulation surface 1 to the conveyor 2 in such a manner as to enable the machine 4 arranged downstream of the device, for example a parceling machine, to form parcels of products 3 in which each parcel contains different types of products 3, for example by the periodic creation of longitudinal spaces.

The conveyor 2, as shown in FIG. 1, can have two rows of products 3 extending in the direction of forward movement of the conveyor 2 and arranged one beside the other. In this specific embodiment, the transfer means push the products 3, transverse to this direction of forward movement, from an accumulation surface 1 to a specific row of the conveyor 2, specifically the row closest to the surface, which determines the future placement of each product type in the parcels outputted from the machine 4 downstream.

This results in a flow of products 3 that has rows comprising products 3 of different types in different rows. Preferably, the products 3 are conveyed on the conveyor 2 and moved into the parceling machine downstream in several, corridors or rows that extend parallel to the direction of the conveyor 2 and that are arranged next to one another. The products 3 moved from an accumulation surface 1 to the conveyor 2 in a movement transverse to this direction by the transfer means are then in the row or the corridor that is closest to the edge of the conveyor 2, and which is therefore the edge row of the flow moved by the conveyor 2. The products transferred transversely from the accumulation surface are added to the flow from the side.

The accumulation surfaces 1 can be located on each side of the conveyor 2, as shown in FIG. 1, and/or one upstream of the other, as shown in FIG. 2, The use of two accumulation surfaces 1 enables the machine 4 downstream to form parcels made up of at least two products of different types. As shown in FIG. 2, it is also possible to have more than two accumulation surfaces 1, for example four, about the conveyor 2 in order to form parcels comprising multiple products of different types.

As shown in the embodiment in FIG. 1, the products 3 provided by the upper accumulation surface 1 form the edge row of the flow that is highest, and the products provided by the lower accumulation surface 1 form the edge row of the flow that is lowest. Consequently, the whole of the flow provided to the machine downstream can be formed using transverse transfers from one edge or two edges of the conveyor 2, in which the conveyor 2 only moves the products received from the edge and forms the product flow, and in which each accumulation surface moves the products against the edge row at this point.

In the embodiment in FIG. 2, it is the two accumulation surfaces 1 shown on the right-hand side of the figure that move the products 3 to each form the end column of the final flow, respectively, the first coming from the top for the accumulation surface 1 in the top right and the first coming from the bottom for the accumulation surface 1 in the bottom right. The products 3 from the accumulation surface 1 that are of a different type to the others in the flow of products 3 on the conveyor 2, once transferred transversely to the conveyor 2, are in one of two longitudinal edge rows of the multi-row flow of products 3 on the conveyor 2.

In the specific embodiment of the invention shown in FIG. 2, when the two accumulations surfaces 1, on which two different types of products 3 are placed, are positioned one upstream of the other on the same side of the conveyor 2 and the conveyor 2 has two rows of products 3, the transfer means of the accumulation surface 1 furthest upstream can place the products 3 on the row furthest away from the accumulation surfaces 1. Two rows of different products 3 are thus formed and, during transfer of the products 3 from the second accumulation surface 1 to the conveyor 2, the products 3 do not have to be lifted and can be simply pushed. The transverse transfer of different products 3 from the accumulation surface 1 therefore ends on the side of the multi-row flow of products 3 moved by the conveyor 2 at this point.

Any transfer means known to the person skilled in the art can be used to implement the invention. The transfer means can for example be robotic gripping arms for a queue of products 3 that are designed to transfer a queue to a row of the conveyor 2. The transfer means can also be simple means for pushing the queues of products 3 (pushers, plates or other).

It can be seen that the transfer means act in a cyclical manner, such that with each cycle a longitudinal group of at least one product 3 is moved into the flow delivered to the packaging machine downstream.

The queues of products 3 transferred from the accumulation surfaces 1 to the conveyor 2 can be of variable size. The queues may comprise a single product 3 or conversely a large number of products 3. In particular, the edge row of the flow including the products 3 transferred laterally from the accumulation surface 1 furthest downstream can be uniform and therefore comprise only products 3 of the type provided by the accumulation surface 1, or be non-uniform and include products 3 moved from the accumulation surface 1 and products 3 of another type moved into this row from upstream.

The device according to the invention makes it possible to implement a method for forming a batch of different products 3 including the following steps, which may be carried out simultaneously:
transfer of type A products 3 from the first accumulation surface 1 to the conveyor 2,
transfer of type B products 3 from the second accumulation surface 1 to the conveyor 2.

During this method, the products 3 can be transferred to different rows of the conveyor 2 as a function of the type thereof (A or B). The products 3 can also be transferred to the same row of the conveyor 2, which will be a non-uniform row of A and B products. As a result, the edge row, i.e. one of the transverse end rows of the flow, comprises products 3 of a first type arriving transversely from an accumulation surface 1, then products 3 of a second type arriving from an accumulation surface 1 positioned on the same side, either upstream or downstream.

The device according to the invention enables the machine 4 downstream to form different types of parcel comprising products 3 of different types.

If the rows of the conveyor 2 only have one type of product 3 each, as shown in FIGS. 1 and 2, the parcels obtained can comprise different types of products 3 in the transverse direction of the conveyor 2 and identical products in the longitudinal direction of the conveyor 2. All of the parcels outputted by the machine 4 are then identical.

For example, in the embodiment shown in FIG. 2, batches of four different types of products 3 are formed. The four different types of products 3 come from four different accumulation surfaces 1, from which said products are transferred to four adjacent rows of the conveyor 2, symmetrically between the two sides of the conveyor 2, in which the accumulation surface 1 furthest downstream feeds the row of the final flow that is closest thereto, and that is therefore the edge row at that point. The machine 4 downstream can then for example form parcels from a queue of four products 3 of different types, or from two queues of four products 3 of different types.

Conversely, if one or more queues on the conveyor 2 are non-uniform and include products 3 of different types, for example two types of products 3 alternating with one another, the parcels outputted from the machine 4 downstream may be made up of products 3 that are different not only in the transverse direction of the conveyor 2, but also in the longitudinal direction of the conveyor 2. It is also possible for different parcels to be obtained, for example parcels made up of different types of products 3 alternating with one another.

For example, there could be a conveyor 2 with two rows, one of the rows comprising a single type of product 3 and the other row comprising two types of products 3 alternating with one another. Depending to the layout of the machine 4 downstream, it is then for example possible to provide parcels of two products 3 that are alternately of two different types, or to provide parcels of three different types of products 3, in which all of the parcels are identical.

In order to obtain lots entering the machine 4 downstream in which at least one of the edge rows is non-uniform, there may be several accumulation surfaces 1 one behind the other along the conveyor 2. An accumulation surface moves the related products to a row further away than the destination row for the products of an accumulation surface downstream of the first surface.

Where applicable, the device according to the invention makes it possible to form adjacent rows of products 3 that are of a different type from one row to the next using a compact installation, thereby making it possible to easily form parcels of products 3 comprising three different products in the machine 4 downstream. The solution is flexible and makes it possible to easily change the composition parameters of the parcels of products 3. An existing line for handling products 3 can be adapted to the invention, and as such a dedicated line is no longer required to make parcels comprising three different products. Furthermore, the device according to the invention makes it possible to use any type of accumulation surface 1, regardless of the installation upstream for each line and in particular the methods used to fill the accumulation surfaces 1.

The device according to the invention can be used downstream of a line already containing products 3. Upstream of the at least one accumulation surface, the conveyor 2 can convey the products 3 coming from upstream of the device and the device can transfer the products 3 to one or more free rows on the conveyor 2 and/or to one or more rows with free spaces for the insertion of products 3.

According to a specific embodiment, at least one accumulation surface 1 can be the surface of an independently movable shuttle or a table carried by a shuttle that is detachable therefrom. When empty, said shuttle can return to the machine upstream to be reloaded, while another shuttle, whose surface has been previously loaded with products 3, takes the place of the first shuttle near to the conveyor. Once the surface of this second shuttle has been emptied, the first shuttle can have been reloaded and be ready to take the place of the second shuttle near to the conveyor 2.

According to another embodiment, at least one accumulation surface 1 can be fed by unpacking means designed to feed said accumulation surface 1 from at least one box, for example of robot designed to simultaneously pick the batch or a sub-batch of B products from a box. Once a box is empty, the box may be replaced by another box to continue feeding the accumulation surface 1.

According to another embodiment, at least one accumulation surface 1 can be fed by an input conveyor of one or more parallel rows. Pushing means, for example a robotic arm, are arranged such as to push the product arriving via the input conveyor onto the accumulation surface. According to a specific embodiment, such pushing means may have several pushing faces enabling said means to push a lot of several rows at a time. It is also possible for the transfer means from the accumulation surface to the conveyor 2 to be designed to push several rows at once, if several rows of products of the same type are required on the conveyor 2. For example, the pushing means may have several vertical walls spaced apart at the same distance as the spacing of the rows and held in relation to one another by a horizontal plate arranged, above said wails to form a plurality of inverted “U” shapes side by side.

During the transfer of products 3 from an accumulation surface 1 to the conveyor 2, the conveyor 2 maybe stopped or at least significantly slowed to enable a transfer by sweeping without any risk of the products 3 falling. Once the transfer has been completed, the conveyor 2 can then accelerate back to the nominal speed thereof to convey the flow of products 3 downstream. In certain solutions, the conveyor 2, in the zone where the at least one transverse transfer takes place, has several strips, each strip being dedicated to a row and having an individually customizable speed, or has at least one strip dedicated to circulation of the edge row. This makes it possible to slow the strip of the edge row to compensate for the insertion of the products from the side in relation to the other rows.

To obtain a non-uniform row of products 3, a cycler can be arranged beside the conveyor 2 level with the point at which said non-uniform row is desired. The method for obtaining a non-uniform row can then include the following steps:
Firstly, a row of type A products 3 is formed. This row may be the only row in the flow or may be one of several rows forming the final flow.
The cycler actuates a stop that is placed across the flow or at least across the corridor designed to receive the products from the side, which results in the products 3 upstream of said stop being stopped. As the conveyor 2 moves forward, the products 3 downstream of the stop continue to move downstream. This creates a free space in the row between the last product 3 that has moved downstream and the first product 3 stopped by the stop.
A lot of type B products 3 can then be transferred transversally from an accumulation surface to said row in the free space thus formed. Such a lot of type B products 3 can comprise a single type B product 3 or several type B products 3.
The cycler then releases the stop, which enables the type A products 3 that had been blocked by the stop to continue moving.
After a predetermined time, corresponding to a predetermined number of type A products 3, the cycler actuates the stop again to insert the following lot of B type products 3, and so on.

This creates a non-uniform row comprising type A products 3 and type B products successively.

As explained above, a row of products can be formed by lateral transfer from an accumulation surface 1 to the conveyor 2 or can come from upstream of the device. A row of products can notably be taken from an upstream machine to the conveyor 2, said conveyor then receiving other products by lateral transfer from the accumulation surface.

Thus, all of the rows that are on the conveyor 2 at the end of the method can originate in full from the accumulation surfaces 1 arranged on the side of the conveyor 2 or otherwise.

The invention makes it possible to create parcels with one edge row comprising products 3 of a different type from all of the other products, or in which a single product 3 of the edge row is of a different type from all of the other products 3. All of the combinations of products 3 in a parcel are possible, using transfer methods involving sweeping only, without the need for more complex installations.

Although the description above is based on specific embodiments, this in no way limits the scope of the invention and modifications may be made, notably by means of technical equivalent substitutes or different combinations of all or some of the features discussed above.

1. A method for forming a batch of products on a conveying line, upstream of a packaging station of said batch, said batch containing products of at least two different types, specifically type A and type B, said conveying line including a conveyor (2) arranged in the longitudinal direction, and designed to, move the products in parallel rows towards the packaging station, and at least one accumulation surface (1) arranged adjacent to and flush with said conveyor (2), the method comprising:
formation of at least one row of A products on the conveyor (2), and
transverse cyclical transfer by lots of B products from said accumulation surface (1) to the conveyor (2).

2. The method as claimed in claim 1, in which the B products are transferred to a dedicated row for B products.

3. The method as claimed in claim 1, in which the row of A products is interrupted, and the B products are transferred to the row of A products at the interruption point thereof.

4. The method as claimed in claim 1, in which the A products are loaded onto the conveyor (2) upstream of the transfer of the B products.

5. The method as claimed in claim 1, in which the speed of said conveyor (2) is slowed during the transfer of B products, then increased to a nominal value greater than the speed of forward movement of the rows in a machine downstream.

6. The method as claimed in claim 1, further comprising:
formation of at least two rows, at least one of which includes A products on said conveyor (2),
stopping the row with the A products using stopping means to cause an interruption of the row,
transfer of at least one B product to said interruption, such as to create a row with two products (A and B).

7. The method as claimed in claim 1, further comprising:
formation of at least two rows, at least one of which includes A products on said conveyor (2),
transfer of B products from an accumulation surface (1) arranged on one side or said conveyor (2),
transfer of C products from an accumulation surface (1) arranged on the other side of said conveyor (2), in which the C products may be identical to the B products.

8. The method as claimed in claim 1, in which B products from a second accumulation surface (1) are transferred to the conveyor (2) once the products from the first accumulation surface (1) have all been transferred.

9. A device for implementing a method as claimed in claim 1, including a conveyor (2) with at least two corridors, having at least one accumulation surface (1) arranged immediately beside and flush with said conveyor (2), and means for transferring products from said accumulation surface (1) to the conveyor (2), on the corridor closest to the accumulation surface (1), said transfer means being preferably pushing means.

10. The device as claimed in claim 9, further comprising a second accumulation surface (1) arranged on the same side of said conveyor (2) as the first accumulation surface (1).

11. The device as claimed in claim 9, in which said conveyor (2) has a variable-speed motor ranging from a near-zero speed, in order to transfer products from the accumulation surface (1), to a maximum speed, in order to convey said products downstream.

12. The device as claimed in claim 9, in which said conveyor (2) has means for stopping a row that are designed to temporarily stop the products upstream of said stopping means of said row to enable the transfer means to transfer at least one product from the accumulation surface (1) to said row.

13. The device as claimed in claim 9, in which said accumulation surface (1) is arranged on an independently moveable shuttle.

14. The device as claimed in claim 9, further comprising an unpacking means designed to feed said accumulation surface (1) by a robot designed to simultaneously pick the batch or a sub-batch of B products from a box.

15. The device as claimed in claim 9, also including an input conveyor arranged substantially parallel to the conveyor (2) on the other side of the accumulation surface (1) in relation to said conveyor (2), and transfer means from said input conveyor to the accumulation surface (1).
